(19) United States
(12) Patent Application Publication
(10) Pub. No.: US 2018/0210186 A1
(43) Pub. Date: Jul. 26, 2018

(54) IMAGE PROCESSING APPARATUS, IMAGE PROCESSING SYSTEM, MICROSCOPE SYSTEM, IMAGE PROCESSING METHOD AND COMPUTER-READABLE RECORDING MEDIUM

(71) Applicant: OLYMPUS CORPORATION, Tokyo (JP)

(72) Inventor: Shunichi Koga, Tokyo (JP)

(73) Assignee: OLYMPUS CORPORATION, Tokyo (JP)

(21) Appl. No.: 15/927,140

(22) Filed: Mar. 21, 2018

Related U.S. Application Data
(63) Continuation of application No. PCT/JP2015/079610, filed on Oct. 20, 2015.

(51) Int. Cl. G02B 21/36; H04N 5/232; H04N 5/243; G02B 21/26

(52) U.S. Cl. CPC G02B 21/365; H04N 5/232; G02B 21/26; G02B 21/361; H04N 5/243

(57) ABSTRACT

An image processing apparatus includes: an image acquiring unit configured to acquire a first image group and a second image group in a first and a second direction different from each other, respectively, each image group including a pair of images sharing a common region in which a part of a subject is commonalized between one image and another image of the pair; and an optical axis center detection unit configured to detect a center of an optical axis of observation light forming the images based on a variation amount of a shading component in the first and second directions based on luminance of the common region of each of the first and second image groups.

### CROSS-REFERENCE TO RELATED APPLICATION

This application is a continuation of PCT international application Ser. No. PCT/JP2015/079610 filed on Oct. 20, 2015, which designates the United States, incorporated herein by reference.

### BACKGROUND

The present disclosure relates to an image processing apparatus, an image processing system, a microscope system, an image processing method, and a computer-readable recording medium.

In the related art, there is known a microscope provided with a light source that illuminates a specimen, an optical system that magnifies an image of the specimen, and an image sensor provided in a rear stage of the optical system to convert the magnified image of the specimen into electronic data. In such a microscope or the like, uneven illuminance of the light source or irregularity of the optical system is generated from the optical system such as a lens or an illumination device. In addition, uneven brightness is generated in the acquired image due to deterioration of a characteristic of the image sensor or the like in some cases. This uneven brightness is called “shading,” typically, by which the brightness is gradually reduced from the center of the image corresponding to a position of the optical axis of the optical system.

In this regard, during manufacturing, an optical axis center of observation light incident to the image sensor may be deviated from the center of the image sensor in some cases due to an error in an assembly work or installation of the illumination lamp or the like. In this case, a shading center may not match a screen center. When the shading center does not match the screen center, it is difficult to obtain an optimum observation image. For example, JP 2007-171455 A discusses an image sensing device that detects a deviation between the optical axis center of the observation light and the center of the image sensor. In the technique of JP 2007-171455 A, the optical axis center of the observation light is detected based on a luminance or saturation of a sampling point extracted in a specimen-absent state or from an empty specimen position within a field of view. In addition, the optical system performs adjustment (centering) based on the deviation between the optical axis center of the observation light and the center of the image sensor.

### SUMMARY

An image processing apparatus according to one aspect of the present disclosure may include: an image acquiring unit configured to acquire a first image group and a second image group in a first and a second direction different from each other, respectively, each image group including a pair of images sharing a common region in which a part of a subject is commonalized between one image and another image of the pair; and an optical axis center detection unit configured to detect a center of an optical axis of observation light forming the images based on a variation amount of a shading component in the first and second directions based on luminance of the common region of each of the first and second image groups.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a block diagram illustrating an exemplary configuration of an image processing system including an image processing apparatus according to a first embodiment;

FIG. 2 is a schematic diagram for describing a method of imaging a subject;

FIG. 3 is a schematic diagram for describing a method of imaging a subject;

FIG. 4 is a flowchart illustrating operations of the image processing apparatus of FIG. 1;

FIG. 5 is a diagram illustrating an image captured by deviating a field of view;

FIGS. 6A and 6B are diagrams illustrating a flatness distribution in each of horizontal and vertical directions;

FIG. 7 is a schematic diagram for describing a process of detecting a flat region;

FIG. 8 is a diagram illustrating an exemplary presentation image displayed by a display device of the image processing system according to the first embodiment;

FIG. 9 is a diagram illustrating an exemplary presentation image displayed by a display device of an image processing system according to a first modification of the first embodiment;

FIG. 10 is a diagram for describing a process of determining a center position using a center position determination unit of an image processing system according to a second modification of the first embodiment;

FIG. 11 is a diagram illustrating a process of determining a center position using the center position determination unit of the image processing system according to the second modification of the first embodiment;

FIG. 12 is a block diagram illustrating an exemplary configuration of an image processing system having an image processing apparatus according to a second embodiment;

FIG. 13 is a schematic diagram for describing a process of detecting a center of the flat region according to the second embodiment;

FIG. 14 is a schematic diagram for describing a process of detecting a center of the flat region according to the second embodiment;

FIG. 15 is a schematic diagram for describing a process of detecting a center of the flat region according to the second embodiment;

FIG. 16 is a schematic diagram for describing a process of detecting a center of the flat region according to a modification of the second embodiment;

FIG. 17 is a diagram illustrating an exemplary configuration of a microscope system according to a third embodiment; and

FIG. 18 is a perspective view illustrating a configuration of a condenser holding portion of the microscope system according to the third embodiment.

### DETAILED DESCRIPTION

Embodiments will now be described in details with reference to the accompanying drawings. Note that this disclosure is not limited by such embodiments. In addition, in each drawing, like reference numerals denote like elements.

### First Embodiment

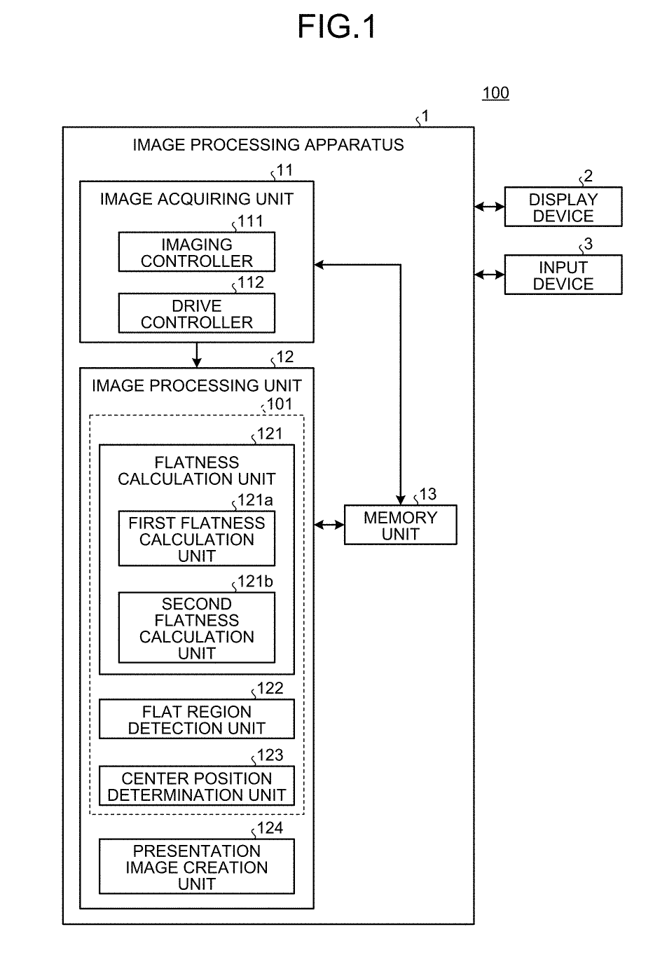

FIG. 1 is a block diagram illustrating an exemplary configuration of an image processing system having an image processing apparatus according to a first embodiment. As illustrated in FIG. 1, an image processing system 100 according to the first embodiment includes an image processing apparatus 1, a display device 2, and an input device 3. The image processing apparatus 1 includes an image acquiring unit 11 that acquires an image signal containing an image on which a subject as an observation target is imaged, an image processing unit 12 that performs image processing for this image, and a memory unit 13.

The image acquiring unit 11 acquires a plurality of images having different imaging fields of view. The image acquiring unit 11 may directly acquire a plurality of images from the image sensing device connected to the image processing apparatus 1 or may acquire a plurality of images via a network or from a memory device or the like. According to the first embodiment, it is assumed that the images are directly acquired from the image sensing device. Alternatively, any type of the image sensing devices may also be employed, such as a microscope device having an imaging function or a digital camera, without a particular limitation.

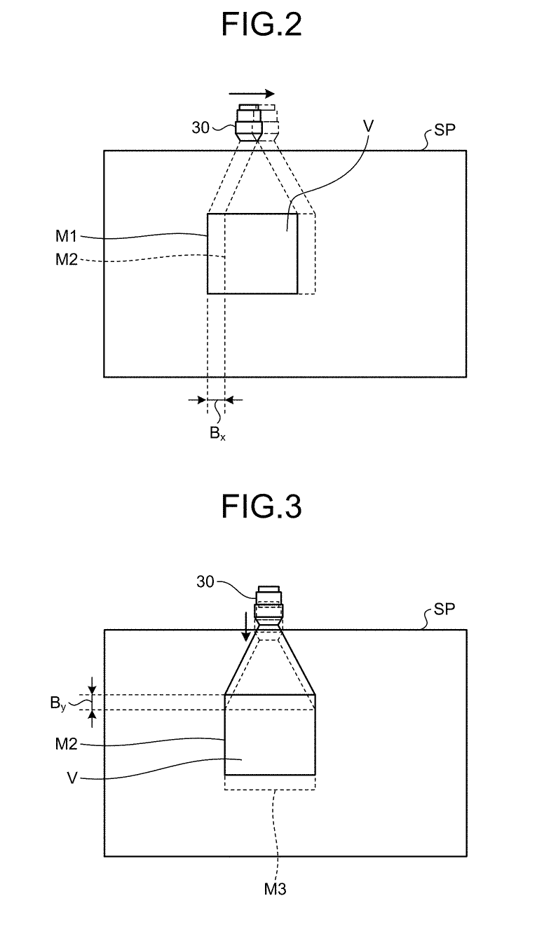

FIGS. 2 and 3 are schematic diagrams for describing operations of the image acquiring unit 11, in which a subject SP, an optical system 30 provided with an image sensing device to form an image of the subject SP, and an imaging field of view V of the optical system 30 are illustrated. In FIGS. 2 and 3, in order to facilitate understanding of a position of the imaging field of view V of the subject SP or the imaging method, a positional relationship with the imaging field of view V is illustrated by deviating a position of the optical system 30 from the subject SP and the imaging field of view V on the front side of the paper plane so as to illustrate a side surface of the optical system 30 in the outside of the subject SP. In the following description, it is assumed that, on a plane including the imaging field of view V, a direction placed in parallel to one side of the imaging field of view V is set to a horizontal direction, and a direction perpendicular to the one side is set to a vertical direction.

The image acquiring unit 11 includes an imaging controller 111 that controls an imaging operation of the image sensing device and a drive controller 112 that controls a change of the position of the imaging field of view V with respect to the subject SP. The drive controller 112 changes the position of the imaging field of view V with respect to the subject SP by relatively shifting any one or both of the optical system 30 and the subject SP. FIG. 2 illustrates a case where the optical system 30 is shifted in the horizontal direction, and FIG. 3 illustrates a case where the optical system 30 is shifted in the vertical direction. The imaging controller 111 allows the image sensing device to capture an image at a predetermined timing in response to a control operation of the drive controller 112 to acquire images M1, M2, . . . , on which the subject within the imaging field of view V is imaged, from the image sensing device.

According to the first embodiment, the imaging field of view V is shifted in two directions perpendicular to each other including the horizontal and vertical directions by way of example. However, the shift direction of the imaging field of view V is not limited to the horizontal and vertical directions as long as they are two different directions. In addition, the two directions for shifting the imaging field of view V are not necessarily perpendicular. In the following description, positions of each pixel of the image M1, M2, . . . will be denoted by “(x, y)”.

The image processing unit 12 executes image processing for detecting a center of the optical axis of the observation light for forming an image from shading components generated in a plurality of images acquired by the image acquiring unit 11. Specifically, the image processing unit 12 includes a flatness calculation unit 121 that calculates the flatness as a gradient of shading generated in the image, a flat region detection unit 122 that detects a flat region having a minimum gradient of the shading component and rarely having shading from the inside of the image, a center position determination unit 123 that determines a center position of the flat region detected by the flat region detection unit 122, and a presentation image creation unit 124 that creates a presentation image displayed on the display device 2. The flatness calculation unit 121, the flat region detection unit 122, and the center position determination unit 123 constitute an optical axis center detection unit 101.

The flatness calculation unit 121 includes a first flatness calculation unit 121a and a second flatness calculation unit 121b. Here, the flatness refers to an index representing the gradient of the shading component between neighboring pixels or pixels separated by several pixels. The first flatness calculation unit 121a calculates the flatness in the horizontal direction from the two images M1 and M2 (first image group, refer to FIG. 2) acquired by shifting the imaging field of view V in the horizontal direction (first direction) with respect to the subject SP. Meanwhile, the second flatness calculation unit 121b calculates the flatness in the vertical direction from the two images M2 and M3 (second image group, refer to FIG. 3) acquired by shifting the imaging field of view V in the vertical direction (second direction) with respect to the subject SP.

The flat region detection unit 122 detects a region where shading is rarely generated in the image, and a variation of the shading component is rarely found, based on the flatnesses in the horizontal and vertical directions calculated by the flatness calculation unit 121. In the following description, this region will be referred to as a “flat region”.

The center position determination unit 123 determines a center position of the flat region detected by the flat region detection unit 122. Specifically, since the center of the flat region may be considered as a center position of the optical axis of the observation light, the center position determination unit 123 determines a position of the pixel which is a center position calculated based on the detected flat region as the center position of the optical axis of the observation light.

The presentation image creation unit 124 creates image data containing the presentation image displayed by the display device 2 based on the image signal acquired by the image acquiring unit 11. The presentation image creation unit 124 executes predetermined image processing for the image signal to create image data containing the presentation image. The presentation image is, for example, a color image having each value of red (R), green (G), and blue (B) colors serving as variables when an RGB colorimetric system is employed as a color space.

The presentation image creation unit 124 creates presentation image data of the presentation image displayed by the display device 2, including the center position of the flat region determined by the center position determination unit 123 and the center position of the presentation image (center position of the imaging field of view).

The memory unit 13 includes a semiconductor memory such as a re-writable flash memory, a random access memory (RAM), and a read-only memory (ROM), a hard disk drive, a recording medium such as a magneto-optical (MO) disc, a compact disc recordable (CD-R) disc, and a digital versatile disc recordable (DVD-R), and a memory device such as a write-read device that writes and reads information to and from the recording medium. The memory unit 13 stores various parameters used by the image acquiring unit 11 to control the image sensing device, image data on the image subjected to the image processing of the image processing unit 12, various parameters calculated by the image processing unit 12, and the like.

The image acquiring unit 11 and the image processing unit 12 are implemented using a general-purpose processor such as a central processing unit (CPU) or a dedicated processor such as various operational circuits that execute a particular function such as an application specific integrated circuit (ASIC). When the image acquiring unit 11 and the image processing unit 12 are implemented using a general-purpose processor, all of the operations of the image processing apparatus 1 are comprehensively controlled by reading various programs stored in the memory unit 13 and transmitting commands or data to each unit of the image processing apparatus 1. In addition, when the image acquiring unit 11 and the image processing unit 12 are implemented using a dedicated processor, the processor may solely execute various processes or may execute various processes in cooperation or combination with the memory unit 13 by using various data or the like stored in the memory unit 13.

The display device 2 includes a display element such as a liquid crystal display (LCD), an electroluminescent (EL) display, or a cathode tube ray (CRT) display, and displays an image or relevant information output from the image processing apparatus 1.

The input device 3 is implemented using a user interface such as a keyboard, a mouse, and a touch panel to receive various types of information.

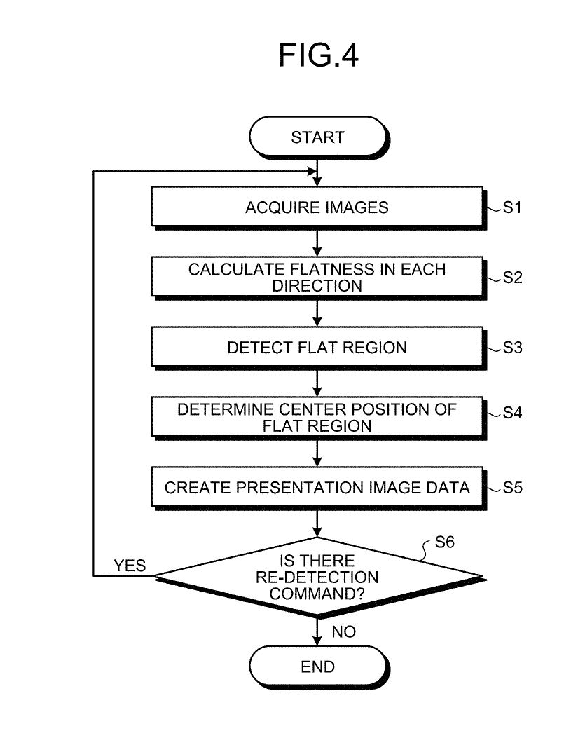

Next, the operation of the image processing apparatus 1 will be described. FIG. 4 is a flowchart illustrating the operation of the image processing apparatus 1. In the following description, it is assumed that images M1 to M3 on which the subject SP illustrated in FIGS. 2 and 3 is imaged are acquired, and correction is performed for these images M1 to M3 by way of example.

First, in Step S1, the image acquiring unit 11 acquires a plurality of images created by imaging the subject SP by shifting the imaging field of view V by a predetermined distance in two different directions. Specifically, the drive controller 112 shifts the imaging field of view V in a predetermined direction by shifting any one of the subject SP and the optical system 30, and the imaging controller 111 performs control such that the imaging field of view V partially overlaps with the other image in the shift direction of the imaging field of view V. Specifically, images M1 and M2 in which the imaging field of view V is deviated in the horizontal direction by a width Bₓ as illustrated in FIG. 2 and images M2 and M3 in which the imaging field of view V is deviated in the vertical direction by a width B_{y} as illustrated in FIG. 3 are acquired. Note that the widths Bₓ and B_{y} (deviation amount between images) are expressed by the number of pixels.

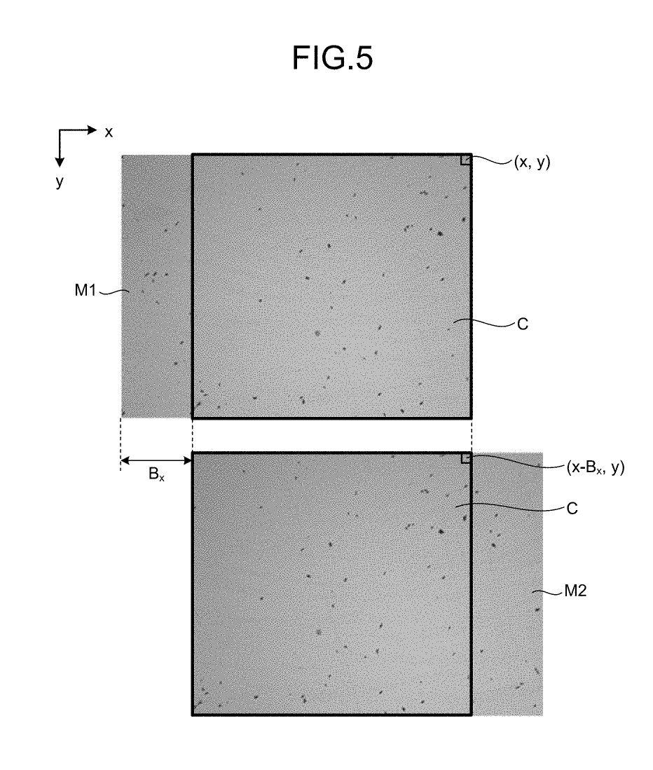

FIG. 5 is a diagram illustrating the images M1 and M2 captured by deviating the imaging field of view V in the horizontal direction. A region of the image M1 excluding the left end width Bₓ and a region of the image M2 excluding the right end width Bₓ are a common region C having a common texture component between the images M1 and M2. In the following description, the luminance of each pixel in the image M1 will be referred to as “I₁(x, y)”, the texture component of the luminance I₁(x, y) will be referred to as “T₁(x, y)”, and the shading component of the horizontal direction will be referred to as “Sh(x, y)”. Similarly, the pixel value (luminance) of each pixel in the image M2 will be referred to as “I₂(x, y)”, the texture component of the luminance I₂(x, y) will be referred to as “T₂(x, y)”, and the shading component will be referred to as “Sh(x, y)”. That is, the luminances I₁(x, y) and I₂(x, y) are given by the following Equations (1) and (2), respectively.

I₁(x,y)=T₁(x,y)×Sh(x,y) (1)

I₂(x,y)=T₂(x,y)×Sh(x,y) (2)

Subsequently, in Step S2, the flatness calculation unit 121 calculates flatnesses in each of the horizontal and vertical directions.

As illustrated in FIG. 5, when the imaging field of view V is deviated in the horizontal direction by the width Bₓ between the images M1 and M2, the texture components T₁(x, y) and T₂(x−Bₓ, y) are common between the pixel (x, y) of the image M1 and the pixel (x−Bₓ, y) of the image M2. Therefore, the following Equation (3) is established.

$${T}_{1} ( x , y ) = {T}_{2} ( x - {B}_{x} , y ) = \frac{{I}_{1} ( x , y )}{Sh ( x , y )} = \frac{{I}_{2} ( x - {B}_{x} , y )}{Sh ( x - {B}_{x} , y )} \qquad ( 3 )$$

That is, a luminance ratio between the pixels whose texture components T₁(x, y) and T₂(x−Bₓ, y) are common represents a ratio of the shading component Sh between the pixels separated by the width Bₓ in the horizontal direction. In this regard, according to the first embodiment, as expressed in the following Equation (4), a logarithm is applied to the ratio of the shading component Sh between the pixels separated by the width Bₓ in the horizontal direction, and an absolute value of this logarithm is calculated as a flatness Flatₕ of the horizontal direction.

$$\begin{matrix}{Flat}_{h} = Abs \{ log ( \frac{{I}_{1} ( x , y )}{{I}_{2} ( x - {B}_{x} , y )} ) \} \\ = Abs \{ log ( \frac{T \times Sh ( x , y )}{T \times Sh ( x - {B}_{x} , y )} ) \} \\ = Abs \{ log ( Sh ( x , y ) ) - log ( Sh ( x - {B}_{x} , y ) ) \}\end{matrix} \qquad ( 4 )$$

Here, since the shading component typically has a low frequency, the luminances I₁(x, y) and I₂(x, y) of Equation (4) are preferably obtained by calculating low-frequency components using a lowpass filter or the like. An artifact generated by an error such as a positioning error or an aberration of the luminance I₁(x, y) or I₂(x, y) without canceling the texture component is alleviated by subtracting (logarithmic subtraction) the low-frequency component of the luminance I₁(x, y) or I₂(x, y). For example, the flatness Flatₕ is calculated by substituting the luminances I₁(x, y) and I₂(x, y) of Equation (4) with the low-frequency components I_{L1}(x, y) and I_{L2}(x, y) of the luminances I₁(x, y) and I₂(x, y). This similarly applies to the following Equation (5).

When a moving object exists in the field of view, a position of the moving object is deviated between images, so that the texture components are not canceled, and a significant error is generated. In this case, the moving object region is detected through a moving object region detection process known in the art, such as thresholding for a difference between images, and such a region is interpolated with the flatness of a neighboring region. A region having a blown-out highlight or black defect from which the shading component is not detected is also interpolated with a neighboring value in this manner. In addition, the flatness Flatₕ may be stably calculated by obtaining images by repeatedly shifting the field of view in the horizontal direction by the width Bₓ and calculating and averaging the flatnesses Flatₕ from a plurality of image pairs.

Similarly, as expressed in the following Equation (5), an absolute value of the logarithm of the ratio of the shading component Sv between pixels separated by the width B_{y} in the vertical direction is calculated as the flatness Flatᵥ of the vertical direction.

$$\begin{matrix}{Flat}_{v} = Abs \{ log ( \frac{{I}_{2} ( x , y )}{{I}_{3} ( x , y - {B}_{y} )} ) \} \\ = Abs \{ log ( \frac{T \times Sv ( x , y )}{T \times Sv ( x , y - {B}_{y} )} ) \} \\ = Abs \{ log ( Sv ( x , y ) ) - log ( Sv ( x , y - {B}_{y} ) ) \}\end{matrix} \qquad ( 5 )$$

Alternatively, as described below, since the flatnesses Flatₕ and Flatᵥ are calculated in order to search a region having a relatively small gradient of the shading component within an image, the logarithms used in Equations (4) and (5) may be either a natural logarithm or a common logarithm.

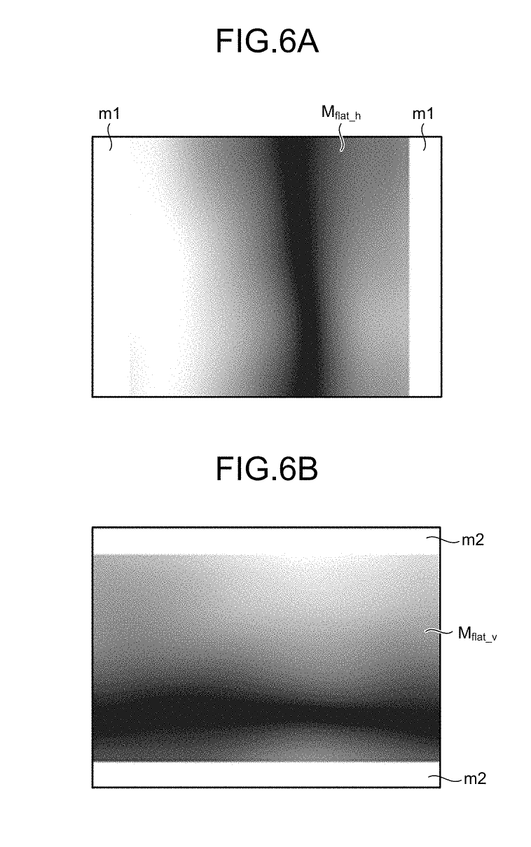

FIGS. 6A and 6B are flatness maps created by setting the flatnesses Flatₕ and Flatᵥ calculated in Equations (4) and (5) as pixel values to illustrate a flatness distribution in each of the horizontal and vertical directions. In FIG. 6A, the flatness map M_{flat}_{_}ₕ shows a flatness distribution in the horizontal direction. Here, since the flatness is calculated only for the common region C as illustrated in FIG. 5, the size of the flatness map M_{flat}_{_}ₕ is reduced by the widths Bₓ in both ends of the images M1 and M2. In this regard, the sizes of the images M1 and M2 are uniformized by adding a margin m1 corresponding to a half of the width Bₓ/2 to both the left and right ends in the flatness map M_{flat}_{_}ₕ. Similarly, a margin m2 corresponding to a half of the width B_{y}/2 is added to both upper and lower ends in the flatness map M_{flat}_{_}ᵥ of the vertical direction illustrated in FIG. 6B.

As the gradient of the shading component is reduced, that is, as the values of the shading components Sₕ₁(x, y) and Sₕ₂(x, y) become closer, the value of the flatness Flatₕ is reduced, and the pixel value in the flatness map M_{flat}_{_}ₕ illustrated in FIG. 6A approaches zero (that is, black). This similarly applies to the flatness map M_{flat}_{_}ᵥ of FIG. 6B.

Subsequently, in Step S3, the flat region detection unit 122 detects a flat region based on the flatness maps M_{flat}_{_}ₕ and M_{flat}_{_}ᵥ of each direction created in Step S2.

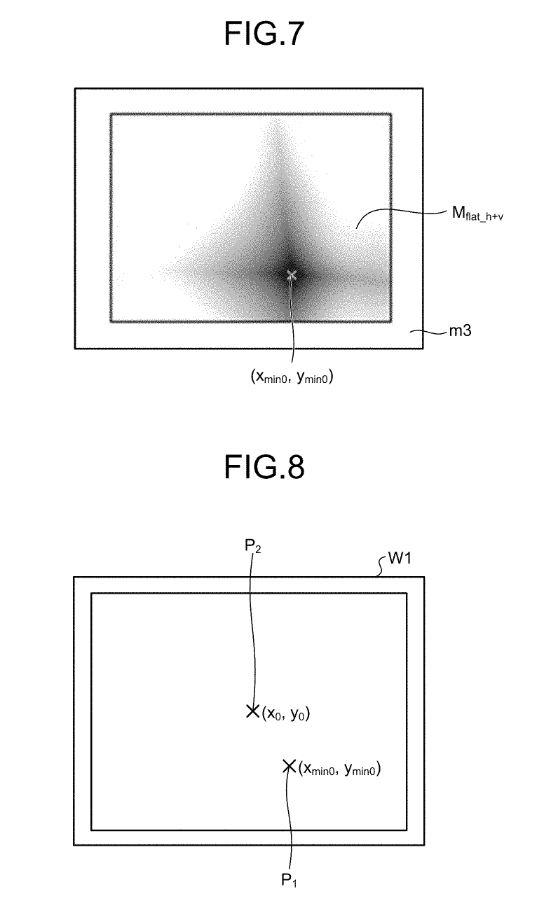

Specifically, first, a synthesized flatness map M_{flat}_{_}ₕ₊ᵥ of FIG. 7 is created by adding the flatness maps M_{flat}_{_}ₕ and M_{flat}_{_}ᵥ of each direction. In this case, the flatness maps are added by excluding portions corresponding to the margins m1 and m2 applied to the flatness map M_{flat}_{_}ₕ and M_{flat}_{_}ᵥ, respectively. Then, the sizes of the images M1 to M3 are aligned by adding a margin m3 around the synthesized flatness map M_{flat}_{_}ₕ₊ᵥ.

Subsequently, in Step S4, the center position determination unit 123 determines a pixel position (xₘᵢₙ₀, yₘᵢₙ₀) where a pixel value of the synthesized flatness map M_{flat}_{_}ₕ₊ᵥ, that is, a sum of the flatnesses Flatₕ and Flatᵥ has a minimum value as a center position of the flat region. The center position determination unit 123 determines the pixel position (xₘᵢₙ₀, yₘᵢₙ₀) which is the detected center position of the flat region as a center position of the optical axis of the observation light. Note that the center position determination unit 123 sets the center of the pixel determined as the pixel of the center position as a center position.

Subsequently, in Step S5, the presentation image creation unit 124 creates presentation image data containing the presentation image displayed on the display device 2 based on the center position of the flat region (pixel position (xₘᵢₙ₀, yₘᵢₙ₀)) determined by the center position determination unit 123 and the center position of the presentation image (center position of the imaging field of view).

FIG. 8 is a diagram illustrating an exemplary presentation image displayed by the display device 2 for describing the presentation image created in Step S5. On the presentation image W1 illustrated in FIG. 8, an optical axis center mark P₁ arranged to match the pixel position (xₘᵢₙ₀, yₘᵢₙ₀) of the center position of the flat region determined by the center position determination unit 123 to indicate a center position of the optical axis of the observation light and an image center mark P₂ indicating a center position of the presentation image W1 (center position of the imaging field of view) are displayed. A user may recognize a deviation between the center of the optical axis of the observation light and the center of the imaging field of view, for example, the center of the image sensor of the image sensing device by checking the presentation image W1.

The user performs adjustment (centering) between the center of the optical axis of the observation light and the center of the image sensor by adjusting the center position of the optical axis of the observation light by shifting, for example, the condensing lens of the microscope or the like depending on this deviation. For example, the center of the image sensor and the optical axis of the lens may be adjusted by displaying and checking the optical axis center mark P₁ and the image center mark P₂ during manufacturing of a digital camera.

Subsequently, in Step S6, the image processing apparatus 1 determines whether or not a command for re-detecting the center of the optical axis of the observation light is input. Here, the image processing apparatus 1 terminates the aforementioned process if there is no input of the re-detection command (Step S6: No). Otherwise, if there is an input of the re-detection command (Step S6: Yes), the flow returns to Step S1 and the image processing apparatus 1 repeats the aforementioned process. For example, the image processing apparatus 1 determines whether or not the re-detection command is input based on a signal input through the input device 3. Note that the re-detection process may be performed on a predetermined time interval basis, and repetition of the process of detecting the center may be set arbitrarily.

A user changes the center position of the optical axis of the observation light by shifting the condensing lens of the microscope or the like and then inputs the re-detection command through the input device 3, so as to approximate the center of the optical axis of the observation light and the center of the image sensor to each other while checking the changed optical axis center mark P₁ and the changed image center mark P₂ every time.

According to the first embodiment described above, a flat region having a minimum gradient of the shading component is detected from an image by rarely generating shading, and the center of this flat region is determined as the center of the optical axis of the observation light. Therefore, it is possible to easily detect the optical axis center of the observation light with high accuracy. As a result, a user may easily and accurately perform adjustment (centering) between the center of the observation light and the center of the imaging field of view (image sensor) by comparing the determined center of the optical axis of the observation light and the center of the imaging field of view. Since the adjustment (centering) between the center of the observation light and the center of the imaging field of view (image sensor) is accurately performed, it is possible to obtain an optimum image by removing a deflection of the observation light.

### First Modification of First Embodiment

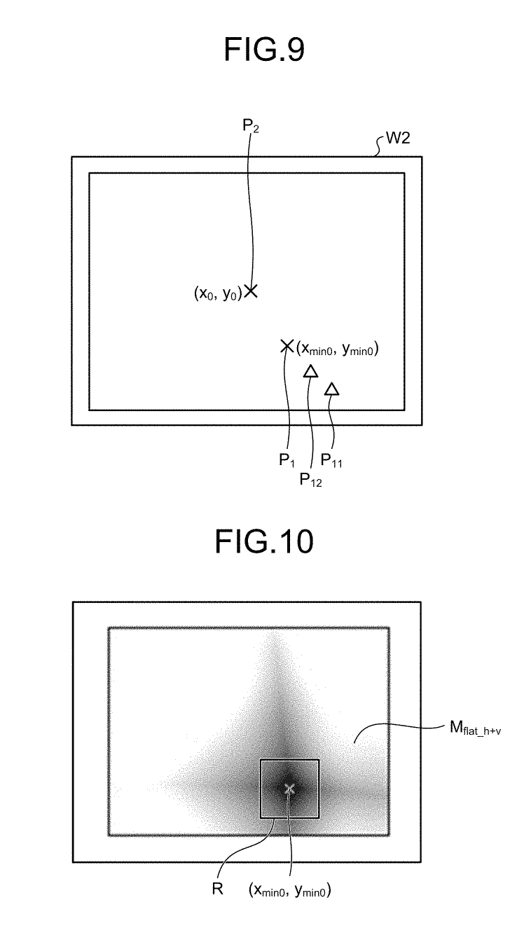

In the first embodiment described above, when there is a re-detection command in Step S6 of FIG. 4, a presentation image is created by detecting the center of the optical axis of the observation light again. That is, only the position of the re-detected center is displayed. Alternatively, a position of the center detected in advance may also be displayed. FIG. 9 is a diagram illustrating an exemplary presentation image displayed by the display device of the image processing system according to a first modification of the first embodiment.

In a presentation image W2 of FIG. 9, the previous optical axis center marks P₁₁ and P₁₂ detected sequentially in last time and last but one time (different times) are displayed in addition to the optical axis center mark P₁ which is the center position of the optical axis of the observation light and the image center mark P₂ detected at the current time. As a result, a user may recognize a shift direction and a shift distance of the optical axis of the observation light caused by a user's manipulation. Therefore, it is possible to more easily perform adjustment (centering) between the center of the observation light and the center of the imaging field of view (image sensor).

Alternatively, in the first modification, the presentation image creation unit 124 may create a locus approximated to a straight line for a plurality of center positions of the optical axes of the observation light detected by the center position determination unit 123 in different times (including the optical axis center mark P₁ and the optical axis center marks P₁₁ and P₁₂) and display it on the display device 2. By displaying the locus, a user may more accurately recognize a shift direction of the center caused by a user's manipulation.

### Second Modification of First Embodiment

In the first embodiment described above, the center position determination unit 123 determines the pixel position (xₘᵢₙ₀, yₘᵢₙ₀), in which a sum of the flatnesses Flatₕ and Flatᵥ is minimized, as a center position of the flat region. Alternatively, the center position of the flat region may be determined using curve fitting.

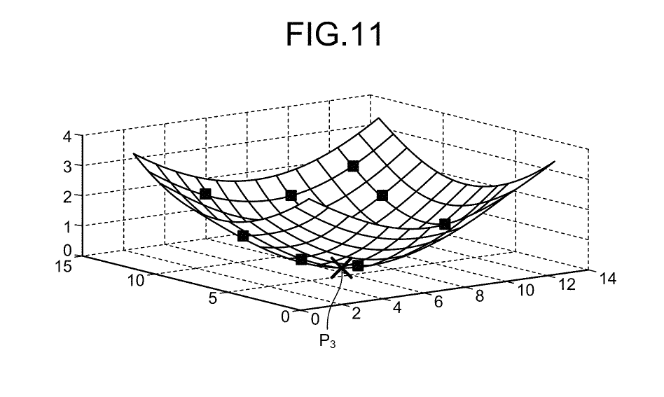

FIG. 10 is a diagram for describing a process of determining the center position using a center position determination unit of an image processing system according to a second modification of the first embodiment to illustrate a curve fitting region in the flat region (synthesized flatness map M_{flat}_{_}ₕ₊ᵥ). FIG. 11 is a diagram for describing a process of determining the center position using the center position determination unit of the image processing system according to the second modification of the first embodiment to illustrate curve fitting. In the graph of FIG. 11, a plane of the abscissa refers to a Cartesian coordinate system including x and y coordinates of the pixel, and the ordinate refers to the flatness.

According to the second modification, the center position determination unit 123 determines the pixel position (xₘᵢₙ₀, yₘᵢₙ₀) in which the sum of the flatnesses Flatₕ and Flatᵥ is minimized as described above in the first embodiment and then performs curve fitting for the region R centered at this pixel position (xₘᵢₙ₀, yₘᵢₙ₀).

Specifically, the center position determination unit 123 performs parabolic curve fitting based on the following Equation (6) which is a quadratic function by way of example.

M(x,y)=ax²+by²+cx+dy+e (6)

Here, “M(x, y)” denotes a pixel value of the pixel (x, y) in the flatness map, that is, a sum of the flatnesses Flatₕ and Flatᵥ. Equation (6) may be modified to the following Equation (7).

$$M ( x , y ) = {a ( x + \frac{c}{2 a} )}^{2} + {b ( y + \frac{d}{2 b} )}^{2} + k \\ ( where “ k ” is an integer ) \qquad ( 7 )$$

In this case, a vertex (−c/2a, −d/2b) of the quadratic function becomes the center of the optical axis of the observation light. From Equation (7), Equation (8) is obtained for the pixel position (xₘᵢₙ₀, yₘᵢₙ₀) of the detected minimum value and four neighboring pixel positions.

$$\{ \begin{matrix}M ( {x}_{min 0} , {y}_{min 0} ) = {ax}_{min 0}^{2} + {by}_{min 0}^{2} + {cx}_{min 0} + {dy}_{min 0} + e \\ M ( {x}_{min 0} - 1 , {y}_{min 0} ) = {a ( {x}_{min 0} - 1 )}^{2} + {by}_{min 0}^{2} + c ( {x}_{min 0} - 1 ) + {dy}_{min 0} + e \\ M ( {x}_{min 0} + 1 , {y}_{min 0} ) = {a ( {x}_{min 0} + 1 )}^{2} + {by}_{min 0}^{2} + c ( {x}_{min 0} + 1 ) + {dy}_{min 0} + e \\ M ( {x}_{min 0} , {y}_{min 0} - 1 ) = {ax}_{min 0}^{2} + {b ( {y}_{min 0} - 1 )}^{2} + c + d ( {y}_{min 0} - 1 ) + e \\ M ( {x}_{min 0} , {y}_{min 0} + 1 ) = {ax}_{min 0}^{2} + {b ( {y}_{min 0} + 1 )}^{2} + c + d ( {y}_{min 0} + 1 ) + e\end{matrix} \qquad ( 8 )$$

By solving Equation (8), the coefficients a, b, c, and d are obtained, so that the vertex (−c/2a, −d/2b) may be calculated. The vertex (−c/2a, −d/2b) is a point P₃ of the curve fitting of FIG. 11. The center position determination unit 123 determines a position corresponding to this point P₃ (vertex (−c/2a, −d/2b)) as the center position of the optical axis of the observation light.

According to the second modification, compared to the first embodiment described above, it is possible to more accurately obtain the center of the optical axis of the observation light. In the first embodiment described above, the center position determination unit 123 sets the center of the pixel determined as the pixel of the center position as a center position. However, according to the second modification, for example, it is possible to more accurately determine the center position in this pixel.

In the second modification, a subpixel estimation method known in the art and used in matching between images may also be employed instead of the curve fitting.

### Second Embodiment

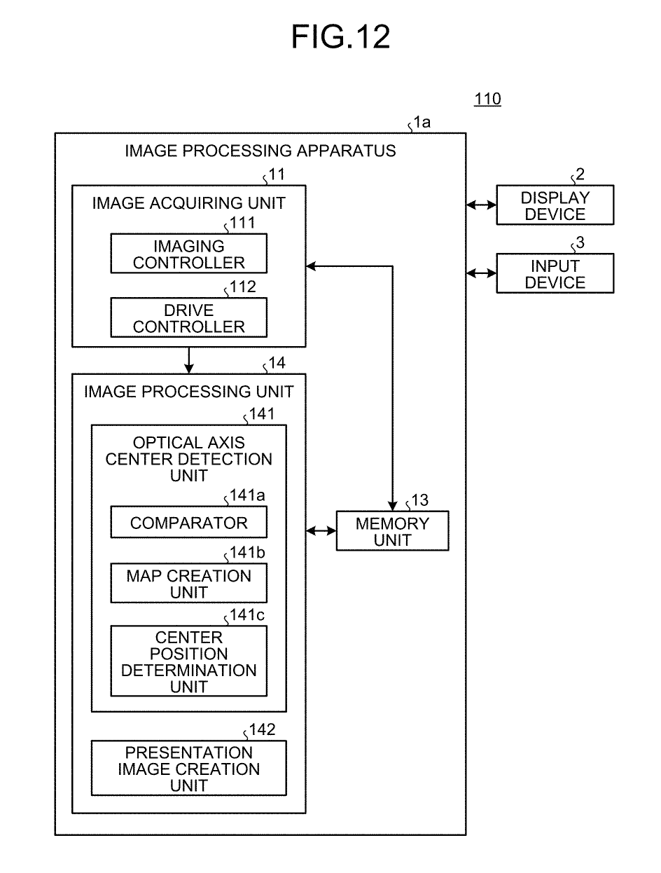

Next, a second embodiment will be described. FIG. 12 is a block diagram illustrating an exemplary configuration of an image processing system having an image processing apparatus according to a second embodiment. Note that like reference numerals denote like elements as in the aforementioned configuration. In the first embodiment described above, the center position determination unit 123 determines the pixel position (xₘᵢₙ₀, yₘᵢₙ₀), in which the sum of the flatnesses Flatₕ and Flatᵥ is minimized, as a center position of the flat region. However, according to the second embodiment, luminances I₁(x, y) and I₂(x, y) of each pixel of the images M1 and M2 are compared, and the center of the optical axis of the observation light is obtained based on a result of this comparison.

An image processing system 110 according to the second embodiment includes an image processing apparatus 1a, a display device 2, and an input device 3 as illustrated in FIG. 12. The image processing apparatus 1a includes an image acquiring unit 11 that acquires an image signal containing an image in which a subject as an observation target is imaged, an image processing unit 14 that performs image processing for this image, and a memory unit 13.

The image processing unit 14 executes image processing for detecting a center of the optical axis of the observation light from shading components generated in the image using the luminances of a plurality of images acquired by the image acquiring unit 11. Specifically, the image processing unit 14 includes an optical axis center detection unit 141 that detects the center of the optical axis of the observation light from the shading components generated in a plurality of images acquired by the image acquiring unit 11 and a presentation image creation unit 142 that generates a presentation image displayed by the display device 2.

The optical axis center detection unit 141 includes a comparator 141a that compares a magnitude relationship between luminances in the common region C of a pair of images acquired by shifting the imaging field of view V in the horizontal direction (first direction) and the vertical direction (second direction), a map creation unit 141b that creates a map (hereinafter, referred to as a “binary map”) by binarizing a comparison result of the comparator 141a, and a center position determination unit 141c that determines a center position of the optical axis of the observation light, which is the center of the flat region described above, from the binary map created by the map creation unit 141b.

Subsequently, a process of detecting the center of the optical axis of the observation light will be described. First, the comparator 141a compares a magnitude relationship between the luminances I₁(x, y) and I₂(x, y) in the common region C (refer to FIG. 5) of a pair of images M1 and M2 (first image group, refer to FIG. 2) acquired by shifting the imaging field of view V in the horizontal direction (first direction). As described in the first embodiment, since the texture component is common in the common region C, the comparison result of the luminance becomes a comparison result of the shading component.

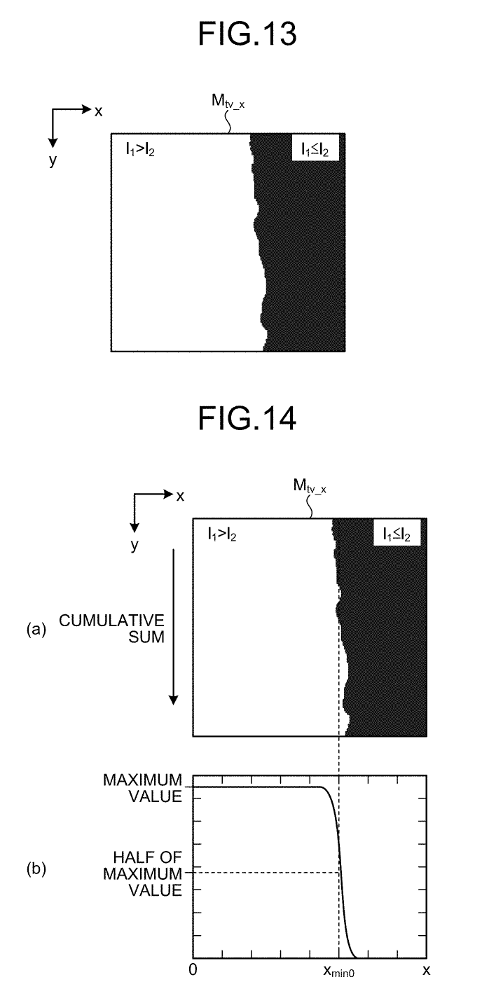

Then, the map creation unit 141b creates a binary map by binarizing the comparison result of the comparator 141a. The map creation unit 141b sets “1” in the corresponding coordinate, for example, when the luminance I₁(x, y) is higher than the luminance I₂(x, y). Meanwhile, the map creation unit 141b sets “0” in the corresponding coordinate, for example, when the luminance I₁(x, y) is equal to or lower than the luminance I₂(x, y). FIG. 13 is a schematic diagram for describing a process of detecting the center of the flat region according to the second embodiment. In FIG. 13, the comparison result of the magnitude of the luminance in the common region C is illustrated as the binary map Mₜᵥ_{_}ₓ having white (for example, set to “1”) and black (for example, set to “0”) colors.

Then, the center position determination unit 141c determines a position where the value changes in the binary map as a center position of the optical axis of the observation light. Here, in the position where the value of the binary map Mₜᵥ_{_}ₓ changes between 0 and 1, it is considered that the shading component is substantially equal between the luminances I₁(x, y) and I₂(x, y) (a variation amount of the shading component is zero or nearly zero), and the shading component is flat. In this regard, in order to obtain the position where the value changes between 0 and 1, the center position determination unit 141c creates a graph, for example, by cumulatively adding the value of the binary map Mₜᵥ_{_}ₓ in the vertical direction (y direction). FIG. 14 is a schematic diagram for describing the process of detecting the center of the flat region to illustrate a graph obtained by cumulatively adding the binary map of FIG. 13 in the vertical direction (y direction). (a) of FIG. 14 illustrates a binary map Mₜᵥ_{_}ₓ created by comparing the luminance. In (b) of FIG. 14, the abscissa refers to a position of the pixel on the x coordinate, and the ordinate refers to a height (cumulative sum) of the image. (b) of FIG. 14 illustrates a curve subjected to smoothing.

Assuming that the white color is set to “1”, and the black color is set to “0” in the binary map, a maximum value of the cumulative sum of the vertical direction becomes a height of the image. Here, the center position determination unit 141c obtains a position on the cumulative sum graph corresponding to a half of the height of the image (a half of the maximum value) and sets this position as the position where the value of the binary map Mₜᵥ_{_}ₓ changes between 0 and 1.

In this manner, the center position determination unit 141c obtains a position xₘᵢₙ₀ where the shading component is flat in the horizontal direction and sets this position xₘᵢₙ₀ as the aforementioned center of the flat region, that is, an x-coordinate of the center of the optical axis of the observation light.

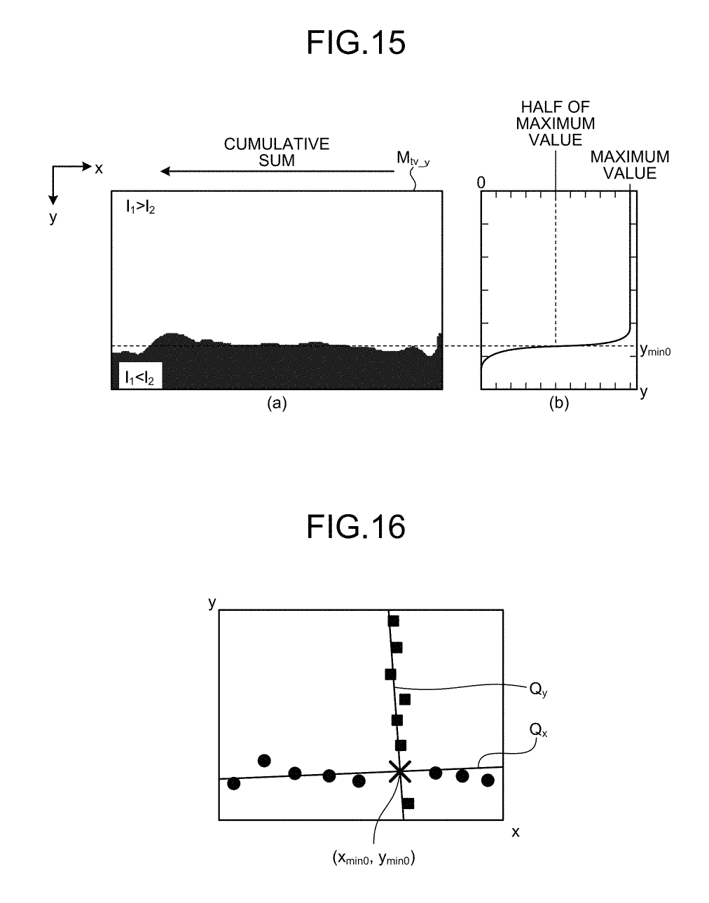

Similarly, the center position determination unit 141c performs this process in the vertical direction, so that a position where the shading component is flat in the vertical direction is obtained using a pair of images M2 and M3 (second image group, refer to FIG. 3) acquired by shifting the imaging field of view V in the vertical direction (second direction), and the y-coordinate of the center of the optical axis of the observation light is obtained. FIG. 15 is a schematic diagram for describing a process of detecting the center of the flat region to illustrate a graph obtained by cumulatively adding the value of the binary map Mₜᵥ_{_}_{y} in the horizontal direction (x direction). (a) of FIG. 15 illustrates the binary map Mₜᵥ_{_}_{y} created by comparing the luminance. In (b) of FIG. 15, the abscissa refers to a height of the image (cumulative sum), and the ordinate refers to y-coordinate of the pixel.

Similarly to the vertical direction, the maximum value of the cumulative sum of the horizontal direction becomes a width of the image. Here, the center position determination unit 141c obtains a position corresponding to a half of the width of the image (half of the maximum value) in the cumulative sum graph and sets this position as the position where the value of the binary map Mₜᵥ_{_}_{y} changes between 0 and 1. In this manner, the center position determination unit 141c obtains a flat position yₘᵢₙ₀ where the shading component is flat in the vertical direction and sets this position yₘᵢₙ₀ as the center of the flat region, that is, the y-coordinate of the center of the optical axis of the observation light.

If the x-coordinate and the y-coordinate of the center of the optical axis of the observation light are determined as described above, the center position determination unit 141c sets these coordinates (xₘᵢₙ₀, yₘᵢₙ₀) as the center position of the optical axis of the observation light. Then, similarly to the first embodiment described above, the optical axis center mark P₁ arranged to match the coordinates (xₘᵢₙ₀, yₘᵢₙ₀) as the determined center position of the optical axis of the observation light to indicate the center position of the optical axis of the observation light, and the image center mark P₂ indicating the center position of the presentation image W1 (center position of the imaging field of view) are displayed on the display device 2. A user may recognize a deviation between the center of the optical axis of the observation light and the center of the imaging field of view, for example, the center of the image sensor of the image sensing device by checking this presentation image.

According to the second embodiment described above, the center of the optical axis of the observation light having nearly no shading is detected based on the luminances of a pair of images having different imaging fields of view, and this center of the flat region is determined as the center of the optical axis of the observation light. Therefore, it is possible to easily detect the center of the optical axis of the observation light with high accuracy. As a result, a user may easily and accurately perform adjustment (centering) between the center of the observation light and the center of the imaging field of view (image sensor) by comparing the determined center of the optical axis of the observation light and the center of the imaging field of view. Since the adjustment (centering) between the center of the observation light and the center of the imaging field of view (image sensor) is accurately performed, it is possible to obtain an optimum image by removing a deflection of the observation light.

According to the second embodiment, the center of the optical axis of the observation light is obtained by comparing luminances of a pair of images. Therefore, it is possible to easily obtain the center of the optical axis of the observation light, compared to the first embodiment described above.

### Modification of Second Embodiment

In the second embodiment described above, a position corresponding to a half of the maximum value of the cumulative sum is determined as the center position of the optical axis of the observation light. Alternatively, straight line fitting using a least square method may be applied to a position where the value of the binary map changes between 0 and 1 in each of the horizontal and vertical directions, so that an intersection point between a pair of straight lines is set as the center of the optical axis of the observation light. FIG. 16 is a schematic diagram for describing a process of detecting the center of the flat region according to a modification of the second embodiment to illustrate a graph obtained by plotting the positions where the value changes between 0 and 1 in the horizontal and vertical directions.

As illustrated in FIG. 16, the center position determination unit 141c plots coordinates where the value changes between 0 and 1 in any position of the horizontal and vertical directions. This graph is synthesized, for example, by matching coordinates of the binary map in the horizontal and vertical directions of FIGS. 14 and 15. In this graph, the abscissa refers to an x-coordinate, and the ordinate refers to a y-coordinate. In FIG. 16, the black circle indicates an arbitrary position of the x-coordinate where the value changes between 0 and 1, and the black square indicates an arbitrary position of the y-coordinate where the value changes between 0 and 1.

The center position determination unit 141c applies straight line fitting using the least square method to each of the positions where the value changes between 0 and 1 (black circle and black square) to calculate a pair of straight lines Qx and Qy. The center position determination unit 141c determines the coordinates of the intersection point between the straight lines Qx and Qy (here, the pixel position (xₘᵢₙ₀, yₘᵢₙ₀)) as the center of the optical axis of the observation light.

Then, similarly to the first and second embodiments, the optical axis center mark P₁ arranged to match the coordinates (xₘᵢₙ₀, yₘᵢₙ₀) as the determined center position of the optical axis of the observation light to indicate the center position of the optical axis of the observation light and the image center mark P₂ indicating the center position of the presentation image W1 (center position of the imaging field of view) are displayed on the display device 2. A user may recognize a deviation between the center of the optical axis of the observation light and the center of the imaging field of view, for example, the center of the image sensor of the image sensing device by checking this presentation image.

In the first and second embodiments described above, the center position of the optical axis of the observation light is adjusted in response to a user's manipulation. Alternatively, the positions of the center of the optical axis of the observation light and the center of the image sensor may be adjusted by shifting the image sensor. Alternatively, an optical axis center adjustment unit may be provided, so that the center position of the optical axis of the observation light is automatically adjusted after the center position of the optical axis of the observation light is determined. For example, assuming that the drive controller 112 or a drive controller provided separately from the drive controller 112 includes a system serving as the optical axis center adjustment unit to automatically shift the condensing lens, the center position determination unit 123 or the drive controller may calculate the shift direction and the shift distance of the center position of the optical axis of the observation light based on the determined center position (coordinates) of the optical axis of the observation light and the center position (coordinates) of the image sensor, and then calculate the shift direction and the shift distance of the condensing lens depending on the calculated shift distance, so that the center position of the optical axis of the observation light may be automatically adjusted by outputting a control signal including the shift direction and the shift distance calculated by the drive controller 112 to the condensing lens shift system and performing a position control.

### Third Embodiment

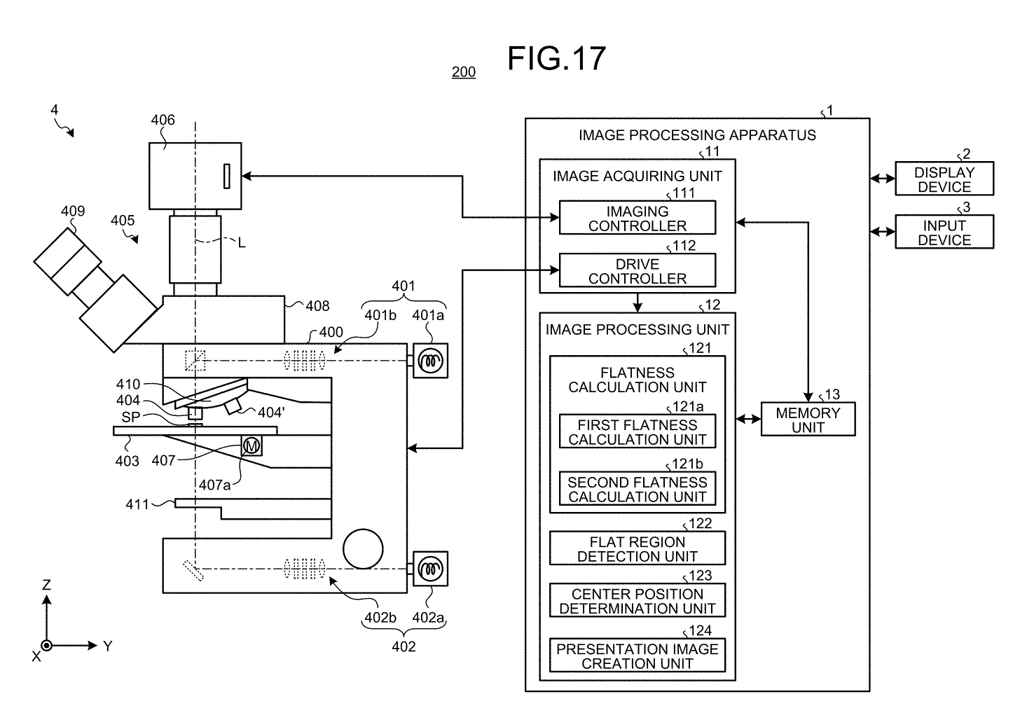

Next, a third embodiment will be described. FIG. 17 is a diagram illustrating an exemplary configuration of a microscope system according to a third embodiment. As illustrated in FIG. 17, a microscope system 200 according to the third embodiment includes the image processing system 100 described above and a microscope device 4. Specifically, the microscope system 200 includes an image processing apparatus 1, a display device 2, an input device 3, and a microscope device 4. The image processing apparatus 1, the display device 2, and the input device 3 are configured similarly to those of the first embodiment. The image processing apparatus 1 performs a process of creating a presentation image based on an image signal acquired from the microscope device 4.

The microscope device 4 includes a substantially C-shaped arm 400 provided with an epi-illumination light unit 401 and a transmitted-light illumination unit 402, a specimen stage 403 installed in the arm 400 to place a subject SP as an observation target, an objective lens 404 provided in one end side of a lens barrel 405 to face the specimen stage 403 by interposing a trinocular lens barrel unit 408, an imaging unit 406 provided in the other end side of the lens barrel 405, a stage position adjuster 407 used to shift the specimen stage 403, and a condenser holding portion 411 that holds a condensing lens. The trinocular lens barrel unit 408 splits the observation light of the subject SP incident from the objective lens 404 into the imaging unit 406 and an eyepiece lens unit 409. The eyepiece lens unit 409 is provided to allow a user to directly observe the subject SP.

The epi-illumination light unit 401 includes an epi-illumination light source 401a and an epi-illumination optical system 401b and irradiates the subject SP with epi-illumination light. The epi-illumination optical system 401b includes various optical members for condensing the illumination light emitted from the epi-illumination light source 401a and guiding the condensed light toward the observation light path L, specifically, such as a filter unit, a shutter, a field-of-view diaphragm, and an aperture diaphragm.

The transmitted-light illumination unit 402 includes a transmitted-light illumination light source 402a and a transmitted-light illumination optical system 402b and irradiates the subject SP with transmitted-light illumination light. The transmitted-light illumination optical system 402b includes various optical members for condensing the illumination light emitted from the transmitted-light illumination light source 402a and guiding the condensed light toward the observation light path L, specifically, such as a filter unit, a shutter, a field-of-view diaphragm, and an aperture diaphragm.

The objective lens 404 is installed in a revolver 410 capable of holding a plurality of objective lenses having different magnification ratios, such as the objective lenses 404 and 404′. The imaging magnification ratio may be changed by rotating the revolver 410 to switch the objective lenses 404 and 404′ facing the specimen stage 403.

The lens barrel 405 internally includes a zooming unit provided with a plurality of zoom lenses and a drive unit for changing positions of the zoom lenses. The zooming unit magnifies or reduces the subject image within the imaging field of view by adjusting positions of each zoom lens. Alternatively, an encoder may be further provided in the drive unit of the lens barrel 405. In this case, an output value of the encoder may be output to the image processing apparatus 1, so that the image processing apparatus 1 may detect the position of the zoom lens from the output value of the encoder and automatically calculate the imaging magnification ratio.

The imaging unit 406 is a camera provided with an image sensor such as a charge coupled device (CCD) or a complementary metal-oxide-semiconductor (CMOS) and capable of acquiring an image signal including a color image having a pixel level (pixel value) in each of red (R), green (G), and blue (B) bands of each pixel of the image sensor. The imaging unit 406 is operated in response to a control of the imaging controller 111 of the image processing apparatus 1 at a predetermined timing. The imaging unit 406 receives light (observation light) incident from the objective lens 404 through the optical system of the lens barrel 405, creates an image signal containing the image corresponding to the observation light, and outputs it to the image processing apparatus 1. Alternatively, the imaging unit 406 may convert the pixel value expressed in the RGB color space into a pixel value expressed in the YCbCr color space and output it to the image processing apparatus 1.

The stage position adjuster 407 includes, for example, a ball screw and a stepping motor 407a and is a shift unit for changing the imaging field of view by shifting the position of the specimen stage 403 on the XY-plane. In addition, the stage position adjuster 407 adjusts a focal point of the objective lens 404 to the subject SP by shifting the specimen stage 403 along the Z-axis. Alternatively, without limiting to the aforementioned configuration, the stage position adjuster 407 may have, for example, an ultrasonic motor or the like.

In the third embodiment, the imaging field of view is changed with respect to the subject SP by shifting the specimen stage 403 while fixing the position of the optical system including the objective lens 404. Alternatively, a shift system for shifting the objective lens 404 on a plane orthogonal to the optical axis may be provided, and the imaging field of view may be changed by shifting the objective lens 404 while fixing the specimen stage 403. Alternatively, both the specimen stage 403 and the objective lens 404 may also be shifted relative to each other.

In the third embodiment, the drive controller 112 of the image acquiring unit 11 performs a position control of the specimen stage 403 by indicating coordinates for driving the specimen stage 403 at a pitch determined in advance based on a value of the scale mounted on the specimen stage 403 or the like. Alternatively, the position control of the specimen stage 403 may be performed based on a result of image matching such as template matching based on the image acquired by the microscope device 4. According to the third embodiment, the imaging field of view V is shifted in the horizontal direction on a plane of the subject SP, and is then shifted in the vertical direction. Therefore, it is possible to very easily perform the control of the specimen stage 403.

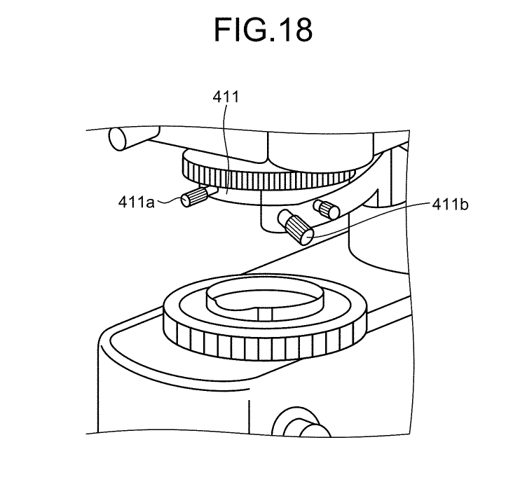

FIG. 18 is a perspective view illustrating a configuration of the condenser holding portion of the microscope system according to the third embodiment. The condenser holding portion 411 holds the condensing lens for adjusting the center position (condensing position of the illumination light) of the optical axis of the observation light and includes a pair of centering knobs (including centering knobs 411a and 411b: optical axis center adjustment unit) for centering the condensing lens. The centering knobs 411a and 411b are screwed to the condenser holding portion 411 and may freely advance and retreat perpendicularly to the optical axis of the condensing lens as it rotates. The condensing lens may move on the plane orthogonal to the optical axis by virtue of the advancing or retreating operation of the centering knobs 411a and 411b. A user performs centering by changing the position of the condensing lens by rotating any one of the centering knobs 411a and 411b.

The centering process of the microscope system 200 is performed, for example, as illustrated in FIG. 4. Specifically, first, in Step S1, the image acquiring unit 11 acquires a plurality of image signals created by the imaging unit 406 of the microscope device 4 by imaging the subject SP (refer to FIG. 2) while shifting the imaging field of view V by a predetermined distance in two different directions.

Subsequently, in Step S2, the flatness calculation unit 121 calculates the flatnesses Flatₕ and Flatᵥ in each of the horizontal and vertical directions. Then, the flatness calculation unit 121 creates flatness maps M_{flat}_{_}ₕ and M_{flat}_{_}ᵥ by setting the calculated flatnesses Flatₕ and Flatᵥ as pixel values (refer to FIGS. 6A and 6B).

Subsequently, the flat region detection unit 122 detects the flat region by creating a synthesized flatness map M_{flat}_{_}ₕ₊ᵥ based on the flatness maps M_{flat}_{_}ₕ and M_{flat}_{_}ᵥ of each direction created in Step S2 (Step S3). Then, the center position determination unit 123 determines a pixel position (xₘᵢₙ₀, yₘᵢₙ₀) corresponding to the pixel value of this synthesized flatness map M_{flat}_{_}ₕ₊ᵥ, that is, a minimum value of the sum of the flatnesses Flatₕ and Flatᵥ, as the center position of the flat region (Step S4). The center position determination unit 123 determines the pixel position (xₘᵢₙ₀, yₘᵢₙ₀), which is the center position of the detected flat region, as the center position of the optical axis of the observation light.

Subsequently, in Step S5, the presentation image creation unit 124 creates presentation image data containing the presentation image displayed in the display device 2 so as to indicate the center position (pixel position (xₘᵢₙ₀, yₘᵢₙ₀)) of the flat region determined by the center position determination unit 123 and the center position of the presentation image (center position of the imaging field of view).

A user may recognize a deviation between the center of the optical axis of the observation light and the center of the imaging field of view, for example, the center of the image sensor of the image sensing device by checking the optical axis center mark P₁ of the presentation image W1 (refer to FIG. 8) and the image center mark P₂ created in Step S5 and displayed in the display device 2.

A user performs adjustment (centering) for the center of the optical axis of the observation light and the center of the image sensor by adjusting the center position of the optical axis of the observation light, for example, by shifting the condensing lens of the microscope or the like depending on this deviation. Specifically, a user changes the center position of the optical axis of the observation light by changing the position of the condensing lens by rotating any one of the centering knobs 411a and 411b.

Then, a user changes the center position of the optical axis of the objective light by shifting the condensing lens of the microscope or the like and then inputs a re-detection command using the input device 3 (Step S6: Yes), so as to approximate the center of the optical axis of the observation light and the center of the image sensor to each other while checking the changed optical axis center mark P₁ and the changed image center mark P₂ every time.

According to the third embodiment described above, since the flat region having the minimum gradient of the shading component is detected from the image without generating shading, and the center of this flat region is determined as the center of the optical axis of the observation light. Therefore, it is possible to easily detect the center of the optical axis of the observation light with high accuracy. As a result, a user may easily and accurately perform adjustment (centering) between the center of the observation light and the center of the imaging field of view (image sensor) by comparing the determined center of the optical axis of the observation light and the center of the imaging field of view. Since adjustment (centering) between the center of the observation light and the center of the imaging field of view (image sensor) is performed accurately, it is possible to obtain an optimum image by removing a deflection of the observation light.

According to the third embodiment, the presentation image creation unit 124 creates a locus approximated to a straight line for a plurality of center positions of the optical axes of the observation light detected by the center position determination unit 123 in different times (including the optical axis center mark P₁ and the optical axis center marks P₁₁ and P₁₂) and displays it on the display device 2. As a result, a user may more accurately recognize the shift direction of the center caused by manipulating the centering knobs 411a and 411b.

In the third embodiment, the center position of the optical axis of the observation light is adjusted by manipulating the centering knobs 411a and 411b. Alternatively, the center position of the optical axis of the observation light may be automatically adjusted after the center position of the optical axis of the observation light is determined. For example, instead of the centering knobs 411a and 411b, a driving system (such as a motor) for shifting the condensing lens on a plane orthogonal to the optical axis may be provided such that the center position determination unit 123 calculates a shift direction and a shift distance of the center position of the optical axis of the observation light based on the determined center position (coordinates) of the optical axis of the observation light and the center position (coordinates) of the image sensor and then calculates a shift direction and a shift distance of the condensing lens depending on the calculated shift distance. As a result, the center position of the optical axis of the observation light may be automatically adjusted by allowing the drive controller 112 (optical axis center adjustment unit) to output the calculated shift direction and the calculated shift distance to the driving system of the condensing lens and performing a position control.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
an image acquiring unit configured to acquire a first image group and a second image group in a first and a second direction different from each other, respectively, each image group including a pair of images sharing a common region in which a part of a subject is commonalized between one image and another image of the pair; and
an optical axis center detection unit configured to detect a center of an optical axis of observation light forming the images based on a variation amount of a shading component in the first and second directions based on luminance of the common region of each of the first and second image groups.

2. The image processing apparatus according to claim 1, wherein the optical axis center detection unit calculates flatnesses indicating a gradient of the shading component in each of the first and second directions based on a luminance ratio in the common region and detects a position in which the gradient of the shading component is minimized as a center position of the optical axis of the observation light based on the flatnesses of the first and second directions.

3. The image processing apparatus according to claim 2, wherein the optical axis center detection unit detects a minimum flatness position obtained through curve fitting for the flatnesses in the common region as the center position of the optical axis of the observation light.

4. The image processing apparatus according to claim 2, wherein the optical axis center detection unit calculates the flatness based on a luminance ratio of a low-frequency component in the common region.

5. The image processing apparatus according to claim 1, wherein the optical axis center detection unit detects a position in which a difference between the luminance of the one image and the luminance of the other image is minimized in the common region as the center position of the optical axis of the observation light based on a magnitude relationship of the luminance in the common region.

6. The image processing apparatus according to claim 1, wherein the optical axis center detection unit creates a binary map based on a magnitude relationship of the luminance in the common region and detects an intersection point between a pair of straight lines obtained through straight line fitting for a plurality of points having different values in each of the first and second directions as the center position of the optical axis of the observation light.

7. The image processing apparatus according to claim 1, further comprising a presentation image creation unit configured to create a presentation image including the center of the optical axis of the observation light detected by the optical axis center detection unit and the center of the image.

8. The image processing apparatus according to claim 7, wherein the presentation image creation unit creates the presentation image so as to display a plurality of the center positions of the optical axes of the observation light detected by the optical axis center detection unit at different times.

9. The image processing apparatus according to claim 7, wherein the presentation image creation unit creates the presentation image so as to display a locus approximated to a straight line for a plurality of the center positions of the optical axes of the observation light detected by the optical axis center detection unit at different times.

10. The image processing apparatus according to claim 1, further comprising an optical axis center adjustment unit configured to adjust the center position of the optical axis of the observation light.

11. An image processing system comprising:
an image processing apparatus including
an image acquiring unit configured to acquire a first image group and a second image group in a first and a second direction different from each other, respectively, each image group including a pair of images sharing a common region in which a part of a subject is commonalized between one image and another image of the pair,
an optical axis center detection unit configured to detect a center of an optical axis of observation light forming the images based on a variation amount of a shading component in the first and second directions based on luminance of the common region of each of the first and second image groups, and
a presentation image creation unit configured to create a presentation image including the center of the optical axis of the observation light detected by the optical axis center detection unit and the center of the image; and
a display device configured to display the presentation image created by the presentation image creation unit.

12. A microscope system comprising:
an image processing apparatus including
an image acquiring unit configured to acquire a first image group and a second image group in a first and a second direction different from each other, respectively, each image group including a pair of images sharing a common region in which a part of a subject is commonalized between one image and another image of the pair,
an optical axis center detection unit configured to detect a center of an optical axis of observation light forming the images based on a variation amount of a shading component in the first and second directions based on luminance of the common region of each of the first and second image groups, and
a presentation image creation unit configured to create a presentation image including the center of the optical axis of the observation light detected by the optical axis center detection unit and the center of the image;
a display device configured to display the presentation image created by the presentation image creation unit;
an optical system configured to form an image of the subject;
a shift unit configured to move a field of view of the optical system with respect to the subject by shifting at least one of the subject and the optical system in the first or second direction;
an imaging unit configured to capture the image of the subject formed by the optical system; and
a stage where the subject is placed,
wherein the shift unit shifts at least one of the stage and the optical system.

13. An image processing method comprising:
acquiring a first image group and a second image group in a first and a second direction different from each other, respectively, each image group including a pair of images sharing a common region in which a part of a subject is commonalized between one image and another image of the pair; and
detecting a center of an optical axis of observation light forming the images based on a variation amount of a shading component in the first and second directions based on luminance of the common region of each of the first and second image groups.

14. A non-transitory computer-readable recording medium on which an executable program is recorded, the program instructing a processor to execute:
acquiring a first image group and a second image group in a first and a second direction different from each other, respectively, each image group including a pair of images sharing a common region in which a part of a subject is commonalized between one image and another image of the pair; and
detecting a center of an optical axis of observation light forming the images based on a variation amount of a shading component in the first and second directions based on luminance of the common region of each of the first and second image groups.
